(19) United States
(12) Patent Application Publication
(10) Pub. No.: US 2018/0320925 A1
(43) Pub. Date: Nov. 8, 2018

(54) APPARATUS FOR NATURAL VENTILATION OF A ROOM

(71) Applicants: Christian CARME, (US); TECHNOFIRST, Aubagne (FR)

(72) Inventor: Christian CARME, Marseille (FR)

(21) Appl. No.: 15/772,886

(22) PCT Filed: Nov. 2, 2016
(86) PCT No.: PCT/FR2016/052834

§ 371 Date: May 2, 2018

(30) Foreign Application Priority Data
Nov. 2, 2015 (FR) 1560493

(51) Int. Cl. F24F 13/24; F24F 13/18; E06B 7/10; G10K 11/178

(52) U.S. Cl. CPC F24F 13/24; F24F 13/18; G10K 2210/112; G10K 11/17875; F24F 2013/247; E06B 7/10

(57) ABSTRACT

An apparatus for natural ventilation of a room, with a room delimited by walls, at least one door or one window installed in one of the room walls, a ventilation passage which is fitted to the door or the window and which communicates between the outside of the room and the inside of said room in such a way as to allow natural ventilation between the outside and inside of said room, the passage having a first end opening into the room and a second end opening to the outside of said room, and a noise absorber capable of attenuating sound waves propagating in the ventilation passage, the attenuation being realized by the generation of a counter-noise which is superimposed on said sound waves or by absorbing all or part of said sound waves.

### TECHNICAL FIELD OF THE INVENTION

The invention has for object an apparatus for natural ventilation of a room.

It relates to the technical field of particular arrangements that make it possible to provide natural ventilation of a room through a door or a window.

### PRIOR ART

It is known through patent documents US2014/0113541 (DRIER), U.S. Pat. No. 6,648,750 (WISEMAN) and WO 2004/070155 (HARDING), ventilation assemblies for buildings comprising a ventilation passage installed on a door or a window.

This ventilation passage communicates between the outside of the building and the inside of said building in such a way as to allow natural ventilation between the outside and the inside of said building. More precisely, it has a first end, closed by a trapdoor and opening into the building, and a second end opening to the outside of said building.

In the WISEMAN apparatus, a noise absorber is installed in the ventilation passage in order to reduce the noise. The absorber comprises at least one control microphone installed to sense the noise in the ventilation passage, and at least one loudspeaker provided with a vibrating membrane suitable for generating a counter-noise in the ventilation passage in response to the noise sensed by the control microphone.

The WISEMAN apparatus has several disadvantages. First of all, it is necessary to provide a trapdoor in order to free the first end of the ventilation passage and initiate natural ventilation. The manipulation and the access to this trapdoor are not necessarily easy for certain people, in particular the elderly. Furthermore, this trapdoor can be the source of a heat loss detrimental to the insulation of the building.

Furthermore, the apparatus is complex to realize and to install. Indeed, the ventilation passage is either installed in the opening frame of the door or of the window, or between the stationary frame and a bearing wall. It is therefore necessary to provide modifications on the frames of the door or of the window and/or a bearing structure for the setting up of the ventilation passage.

The invention aims to overcome this situation. In particular, an objective of the invention is to simplify the design of the ventilation passage as well as the manipulation thereof.

Another objective of the invention is to reduce the risks of a heat leak at the ventilation passage.

Yet another objective of the invention is to simplify the setting up of the ventilation passage.

### DISCLOSURE OF THE INVENTION

The solution proposed by the invention is an apparatus for the ventilation of a room, said apparatus comprising:
a room delimited by walls,
at least one door or one window installed in one of the room walls, which door or which window comprises an opening frame supporting a glass panel, which opening frame is mounted so as to move in a fixed stationary frame surrounding said opening frame,
a ventilation passage provided on the door or the window and communicating between the outside of the room and the inside of said room in such a way as to allow natural ventilation between the outside and inside of said room, which passage has a first end opening into the room and a second end opening to the outside of said room,
a noise absorber capable of attenuating sound waves propagating in the ventilation passage, the attenuation being realized by the generation of a counter-noise which is superimposed on said sound waves,
the door or the window is mounted so as to move between:
   a closed position wherein a profile of the opening frame is hermetically attached to a profile of the stationary frame in such a way as to prevent any ventilation between the inside and outside of the room by the door or the window,
   and an open position wherein the profile of the opening frame is detached and separated from the profile of the stationary frame in such a way as to allow natural ventilation between the inside and outside of the room by the door or the window.

This installation is remarkable in that:
in the closed position, the opening frame hermetically closes the first end of the ventilation passage in such a way as to prevent any ventilation between the inside and outside of the room by said ventilation passage,
in an intermediate open position, the opening frame frees the first end of the ventilation passage, which first end opens into the space separating the profile of the opening frame of the profile of the stationary frame, in such a way as to allow natural ventilation between the inside and outside of the room only by said ventilation passage.

It is now by simply sliding the door or the window that the user can be very simply open or close the first end of the ventilation passage. In addition, it is no longer necessary to provide a trapdoor as in the WISEMAN apparatus, which simplifies the design of the ventilation passage. Furthermore, the door or the window hermetically closing the first end of the ventilation passage, heat losses are reduced, and even zero, at this level.

Other advantageous characteristics of the invention are listed hereinbelow. Each one of these characteristics can be considered alone or in combination with the remarkable characteristics defined hereinabove, and be the object, where applicable, of one or several divisional patent applications:
In the intermediate open position, the profile of the opening frame is preferably separated from the profile of the stationary frame by a distance between 2 cm and 15 cm.
The first end of the ventilation passage can extend vertically along the door or of the window, over a length corresponding substantially to that of the vertical profiles of the opening frame.
The noise absorber comprises at least one microphone arranged to sense the noise in the ventilation passage and at least one loudspeaker adapted to generate a counter-noise in the ventilation passage in response to the noise sensed by the microphone.
Preferably, a switch is adapted to activate the noise absorber.
This switch can be adapted to be controlled by the movement of the door or of the window in such a way that when said door or said window passes from the closed position to the intermediate open position, said switch automatically activates the noise absorber.
The switch can also be adapted to automatically deactivate the noise absorber when the door or the window is in the closed position.
The ventilation passage can have the form of a duct added onto the wall of the room wherein is installed the door or the window, outside of said room.
The ventilation passage can also have the form of a duct integrated into the wall of the room wherein is installed the door or the window, outside or inside said room.
Advantageously, the duct has inner walls that delimit the ventilation passage, which walls are covered with a sound-insulating material.
The stationary frame can be provided with at least one rail whereon slides at least one profile of the opening frame, which rail is provided with an element forming an abutment when the opening frame is in the intermediate open position.
According to a particular embodiment, a duct having an open face can be installed in such a way that said open face is adjacent to the stationary frame, and located outside of the space that separates the profile of the opening frame of the profile of the stationary frame; a transparent plate extends between the opening frame and the stationary frame, from the open face of the duct to the opening frame, which plate extends said duct to the first end of the ventilation passage; the duct and the transparent plate defining the ventilation passage.
Preferably, the ventilation passage has the shape of a chicane.
The ventilation passage can have several channels superimposed parallel one above the other.
The inner walls of a duct delimiting the ventilation passage can be covered with a sound-insulation material.

### DESCRIPTION OF THE FIGURES

Other advantages and characteristics of the invention shall appear when reading the following description of a preferred embodiment, in reference to the annexed drawings, realized by way of indicative and non-limiting examples and wherein:

FIG. 1 is a front view, from the inside of the room, of an apparatus in accordance with the invention according to a first embodiment, with the window in the closed position,

FIG. 2 is a diagrammatical view as a cross-section according to A-A of the apparatus of FIG. 1,

FIG. 3 is a diagrammatical view as a cross-section according to B-B of the apparatus of FIG. 2, from the outside of the room, according to a first alternative embodiment,

FIG. 4 is a front view, from the inside of the room, of the apparatus according to the first embodiment, with the window in the intermediate open position,

FIG. 5 is a diagrammatical view as a cross-section according to C-C of the apparatus of FIG. 4,

FIG. 6 is an enlargement of a detail of FIG. 5,

FIG. 7 is a diagrammatical view as a cross-section according to B-B of the apparatus of FIG. 3, from the outside of the room, according to a second alternative embodiment,

FIG. 8 is a front view, from the inside of the room, of an apparatus in accordance with the invention according to a second embodiment, with the window in the closed position,

FIG. 9 is a diagrammatical view as a cross-section according to D-D of the apparatus of FIG. 8, according to a first alternative embodiment,

FIG. 10 is a diagrammatical view as a cross-section according to E-E of the apparatus of FIG. 9, from the outside of the room,

FIG. 11 is a front view, from the inside of the room, of the apparatus according to the second embodiment, with the window in the intermediate open position,

FIG. 12 is a diagrammatical view as a cross-section according to F-F of the apparatus of FIG. 11,

FIG. 13 is a diagrammatical view as a cross-section according to D-D of the apparatus of FIG. 8, according to a second alternative embodiment,

FIG. 14 is a diagrammatical view as a cross-section according to G-G of the apparatus of FIG. 13, from the outside of the room,

FIG. 15 shows the apparatus of FIG. 13 with the window in the intermediate open position,

FIG. 16 shows an embodiment and an arrangement of an active noise absorber,

FIG. 17 shows another embodiment and an arrangement of an active noise absorber,

FIG. 18 shows an embodiment and an arrangement of a passive noise absorber.

### PREFERRED EMBODIMENTS OF THE INVENTION

This invention relates to an apparatus for natural ventilation of a room, which is characterized by a particular design of the ventilation passage and of the noise absorber that it comprises.

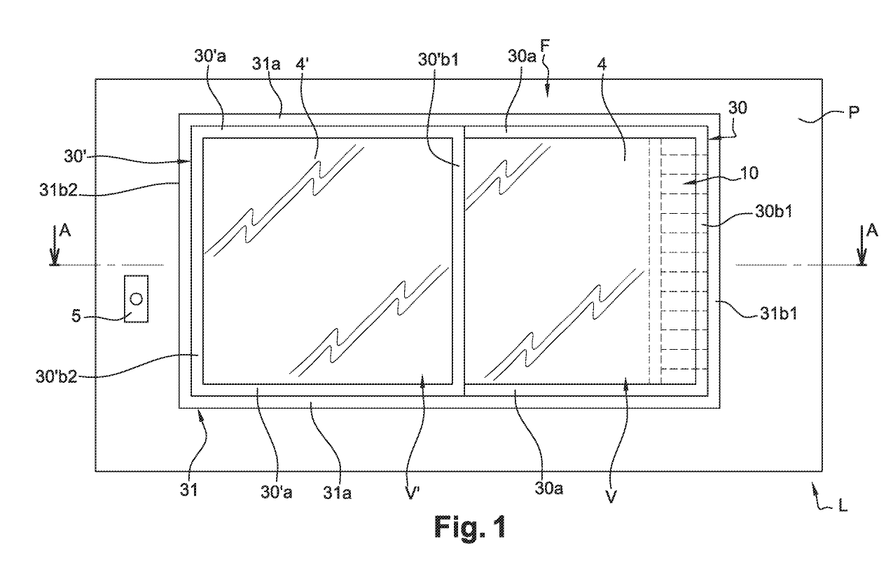

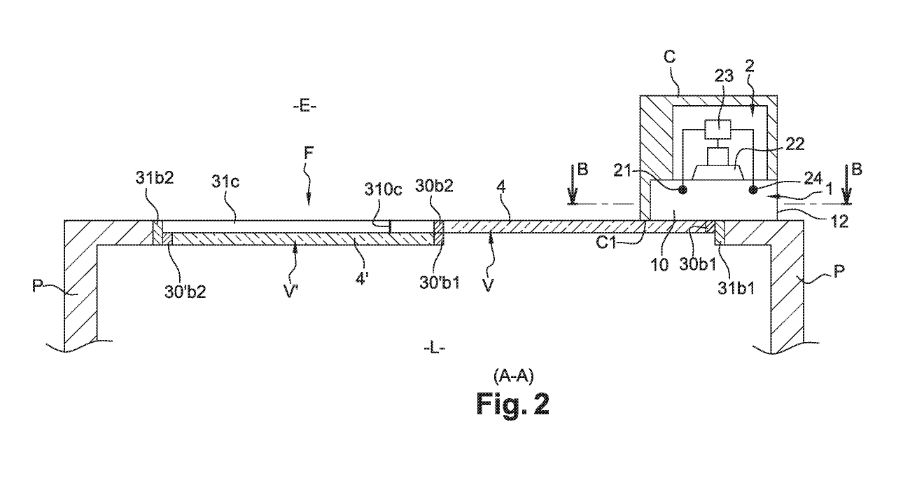

In relation to FIGS. 1 and 2, the apparatus comprises a room L delimited by walls P. This room can be a room in a residence or an office. In this case, the walls P are typically bearing walls.

At least one door or one window F is installed in one of the room L walls P. In order to simplify the understanding of the invention, the rest of the description focuses only on a window F.

This window F is preferably a multi-glazed window, for example double glazing, but can be with single glazing. It forms an interface between the inside of the room L and the outside of said room.

The window F itself is of a known type. It is comprised of one or several leaves V, V′ as shown in FIG. 1. Each leaf V, V′ is comprised of an opening frame 30, 30′ (simply referred to as “opening” in carpentry) formed by horizontal 30a, 30′a and vertical 30b1, 30b2, 30′b1, 30′b2 profiles surrounding at least one glass panel 4, 4′. The opening frames 30, 30′ have a general rectangular shape, which borders the respective panels 4, 4′ according to the four sides thereof. They are more preferably identical.

The opening frames 30, 30′ are mounted movable in a stationary frame 31 (simply referred to as “stationary” in carpentry) fixed to the wall P. This stationary frame 31 is integral with the wall P and more generally with the structural work or with the frame of the assembly where the window must be arranged F. It is also formed by horizontal 31a and vertical 31b1, 31b2 profiles surrounding the opening frames 30, 30′.

In the case where the opening is formed of two leaves V, V′, the dimensions of the opening frames 30, 30′ in width are substantially equal to half of that of the stationary frame 31 that surrounds them. Their dimensions in height are substantially equal to that of the stationary frame 31, to the nearest profile thicknesses. By way of an illustrative example only, the opening frames 30, 30′ have a width of 1.5 m and a height of 2.5 m.

The profiles 30a, 30′a, 30b1, 30b2, 30′b1, 30′b2, 31a, 31b1, 31b2 are rigid, made from metal such as aluminum or other, wood, plastic material, even by combining such materials.

In the example of FIG. 1, the window F is a sliding window. At least the leaf V is able to be displaced by laterally sliding over at least one horizontal support rail 31c mounted in the stationary frame 31, and in particular in its lower portion. The opening frame 30 can include one or several wheel or roller carriages, able to provide the sliding thereof in the rail 31c.

Conventionally, the opening frame 30 is movable between a closed position (FIGS. 1 and 2) wherein it closes the stationary frame 31 and an open position wherein it frees. The open position provides a natural ventilation between the inside and outside E the room L. In the closed position, the two leaves V, V′ are in the extension of one another. The lateral vertical profile 30b1 of the opening frame 30 penetrates into the corresponding vertical profile 31b1 of the stationary frame 31, with these two profiles being hermetically attached. Preferably, these two profiles 30b1, 31b1 include mutual means of locking for blocking the leaf V in this position. Typically, in the closed position, no ventilation between the inside and outside E the room L, is possible by the window F.

In an intermediate open position, the lateral vertical profile 30b1 of the opening frame 30 is detached from the corresponding vertical profile 31b1 of the stationary frame 31, and is separated from the latter by a predetermined distance (for example between 2 cm and 15 cm, preferably 10 cm) when the leaf V slides. Natural ventilation is possible between the inside and outside E the room L, by the window F.

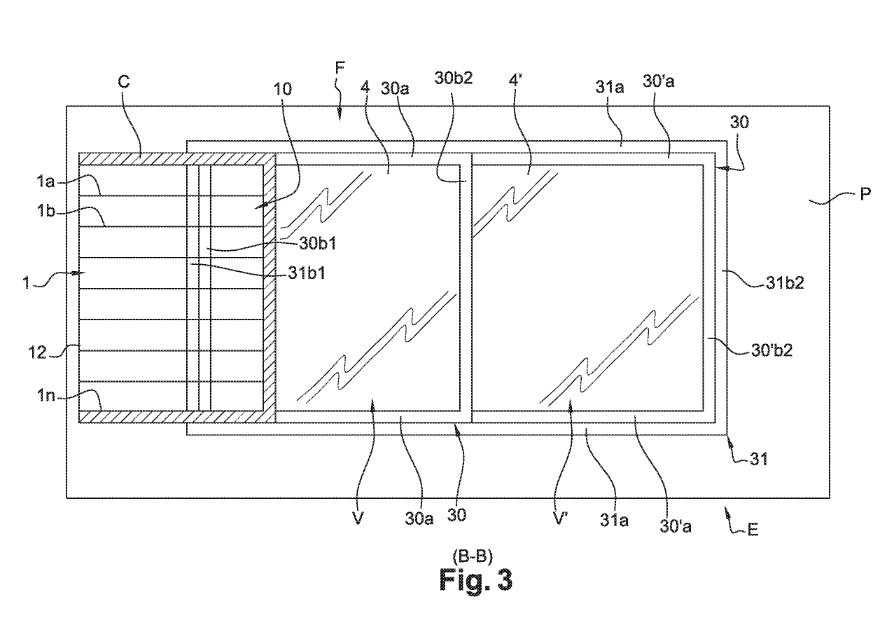

In FIGS. 1 to 6, a ventilation passage 1 is installed at the window F. This passage 1 is a piece of equipment that is combined with the window 1, without it being necessary to modify the latter. This passage 1 can therefore be installed on an existing window F which is already placed in a wall P.

The passage 1 communicates between the outside E of the room L and the inside of said room in such a way as to allow, where applicable, natural ventilation between the outside E and inside of said room. The manner in which this ventilation is made possible is explained hereinafter in the description.

The passage 1 has the form of a duct C added onto the wall P of the room L wherein the window F is installed. For aesthetic considerations, this duct C is preferably installed outside E of the room L. In order to make it invisible from the outside, this duct can be integrated into the wall P, although this arrangement requires prior masonry work. This duct is for example made from metal such as aluminum, stainless steel or other, wood, plastic material, glass in order to be transparent, even by combining such materials. In order to simplify the design, it is advantageously formed of folded sheets assembled together. The duct C is fixed to the wall P by any suitable means of fastening such as screws, adhesive, etc.

In practice, the passage 1 has a first end 10 opening into the room L and a second end 12 opening to the outside E of said room. These ends are materialized by the distal and proximal ends of the duct C. They are advantageously located in two separate planes, and preferably in two orthogonal planes, in such a way that the passage 1 is in the shape of a chicane, this configuration improving the natural ventilation.

The first end 10 extends vertically along the window F, over a length corresponding substantially to that of the vertical profiles 30b1, 30b2. In this way, the ventilation can be realized over the entire length of the window F.

In FIG. 2, the first end 10 is located in the same vertical plane as the opening frame 30, outside E of the window F. It is delimited laterally on the one hand by the vertical profile 31b1 of the stationary frame 31, and on the other hand by the lateral edge C1 of the duct C. This edge C1 is separated by about 5 cm to 20 cm from the vertical profile 31b1, towards the glass panel 4. This edge C1 is advantageously in contact with at least the horizontal profiles 30a of the opening frame 30, and where applicable with the glass panel 4.

In FIGS. 1 to 4, the ventilation passage 1 has several channels 1a, 1b, . . . , 1n (n able to vary from 2 to 15) superimposed parallel one above the other. These various channels are independent and are for example delimited by horizontal plates or sheets installed in the duct C. This conception provides a homogeneous distribution of the flow of ventilated air over the entire length of the window F. This configuration furthermore allows the noise absorber 2 to operate on a wider frequency band between 50 Hz and 2000 Hz, preferably between 70 Hz and 1700 Hz. Indeed, the smaller the section of the channels 1a, 1b, . . . , 1n is, the higher the maximum frequency that can be attenuated by the absorber 2 is). By way of example, each canal 1a, 1b, . . . , 1n has a length between 20 cm and 50 cm. Their section can be square, rectangular or circular. The length of their diagonal of their diameter is for example between 5 cm and 10 cm.

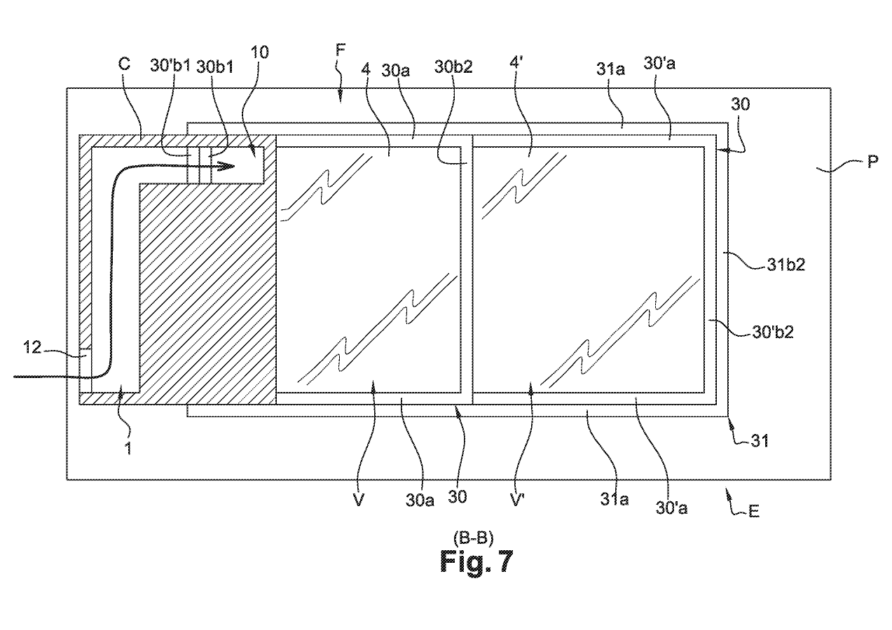

In FIG. 7, the ventilation passage 1 is not tiered, but has a single canal. This single channel extends in the form of a double chicane between the two ends 10 and 12 of the passage 1 (one chicane in the vertical plane of FIG. 7, and another horizontal chicane in the upper portion of the duct C), the first end 10 being arranged in the upper portion of the duct C and the second end in the low portion. An inverse configuration can of course be considered. This design aims to prevent any return of air in the duct C, phenomenon that can occur in the case of the tiered ventilation passage 1 described hereinabove. The single channel provides on the contrary a unidirectional ventilation in the duct C.

In the closed position shown in FIGS. 1, 2 and 3, the window F hermetically closes the first end 10 of the ventilation passage 1 in such a way as to prevent any ventilation between the inside and outside E the room L including any ventilation by said ventilation passage. Indeed, given that the lateral vertical profile 30b1 of the opening frame 30 is hermetically attached to the corresponding vertical profile 31b1 of the stationary frame 31, the first end 10 of the ventilation passage 1 is closed by said opening frame, in particular by the glass panel 4. The air therefore cannot circulate in the duct C.

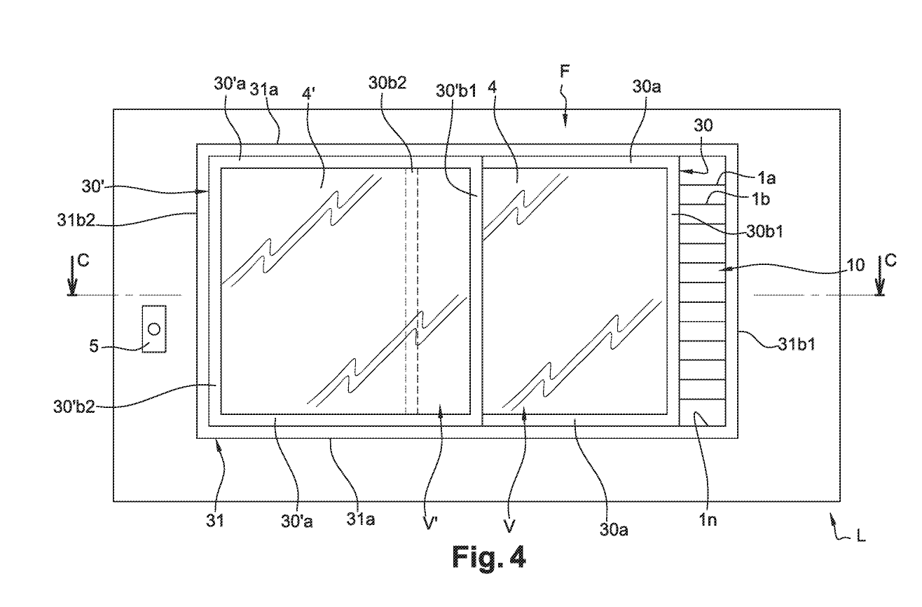

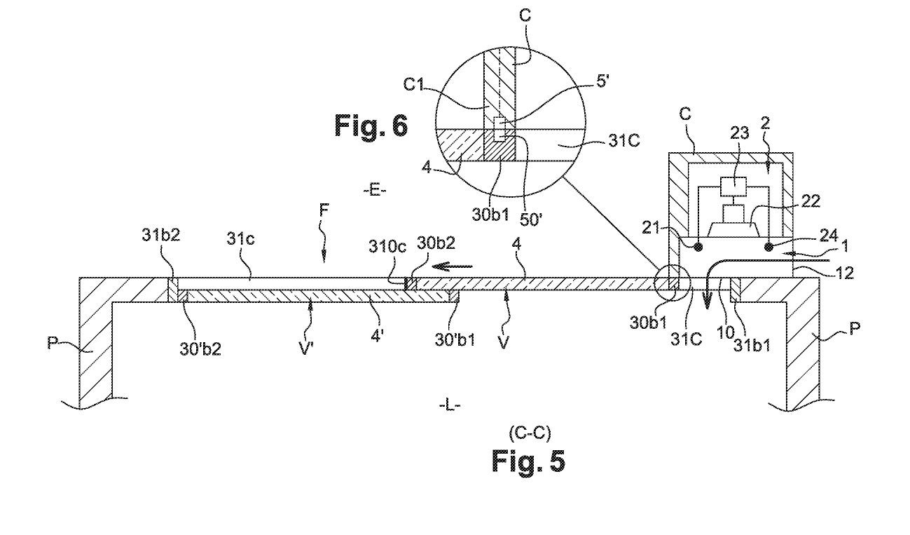

In the intermediate open position shown in FIGS. 4 and 5, the leaf V slides in such a way that the lateral vertical profile 30b1 of the opening frame 30 is moved away from the corresponding vertical profile 31b1 of the stationary frame 31 by a predetermined distance (for example between 2 cm and 15 cm, preferably 10 cm) and is positioned facing the lateral edge C1 of the duct C. The first end 10 of the ventilation passage 1 then opens into the space that separates the lateral vertical profile 30b1 of the opening frame 30 from the corresponding vertical profile 31b1 of the stationary frame 31. It is freed in such a way as to allow natural ventilation between the inside and outside E the room L only by the ventilation passage 1. This natural ventilation is diagrammed in the FIGS. 5 and 7 by the arrow drawn in the passage 1. The space located between the lateral vertical profile 30b1 of the opening frame 30 and the other vertical profile 31b2 of the stationary frame 31 which is opposite the vertical profile 31b1, is entirely closed by the glass panels 4 and 4′, in such a way that the air cannot circulate at this level between the inside and outside E the room L.

In the embodiment of FIGS. 1 to 7, the intermediate open position is reached when the lateral vertical profile 30b1 of the opening frame 30 is positioned facing the lateral edge C1 of the duct C. So that the user can easily reach this position without opening any further the leaf V, it is advantageously provided to install in the rail 31c, an element 310c forming an abutment when the opening frame 30 is in the intermediate open position. This element 310c is clearly visible in the FIGS. 2 and 5 and has for example the form of a rib made of elastomer installed in the rail 31c. When the user wishes to open the leaf V further, it is sufficient for the user to slide said leaf with a moderate effort, in such a way that this rib made from elastomer is retracted under the opening frame 30. As such, when the opening frame 30 is in the open position, i.e. displaced beyond the intermediate open position (the profiles 30b1 and 31b1 being separated by a distance that is greater than the aforementioned predetermined distance), there is a natural ventilation between the inside and outside E the room L not only by the ventilation passage 1, but also at the space located between the lateral vertical profile 30b1 of the opening frame 30 and the lateral edge C1 of the duct C, in the same way as with an open conventional door or window.

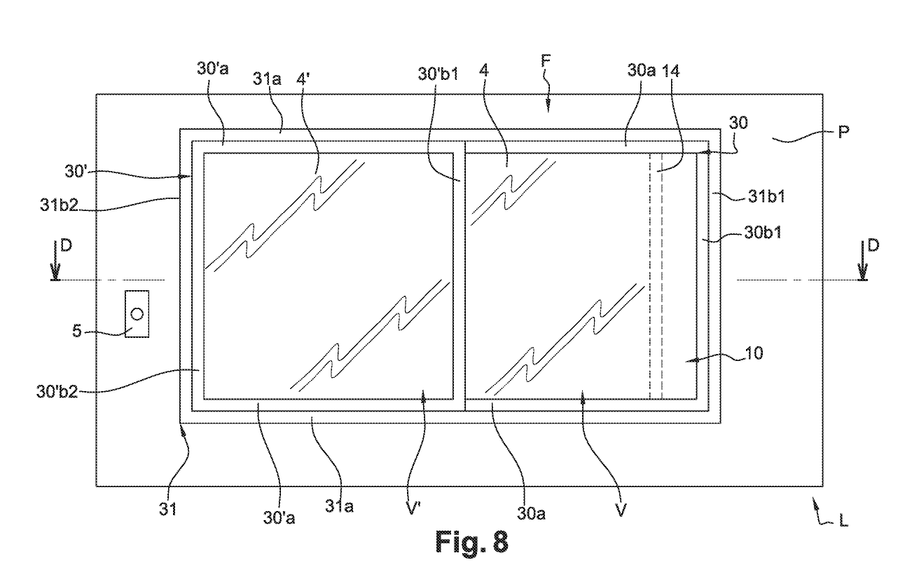

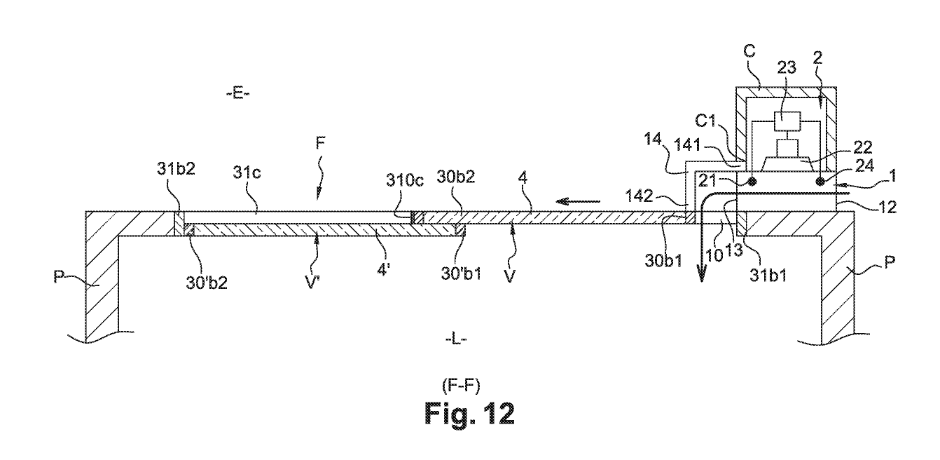

FIGS. 8 to 12 show another embodiment wherein the glass panel 4 is not partially closed by the duct C, contrary to the embodiment described hereinabove. Indeed, in the embodiment of FIGS. 1 to 7, the duct C partially covers the glass panel 4 from the vertical profile 31b1 of the stationary frame 31 to the lateral edge C1, which is able to reduce the total glazed surface of the window F and therefore the lighting of the room L.

In FIGS. 8 to 12, the duct C is adjacent to the stationary frame 31, without covering the glass panel 4. The duct C has an open face 13 which is located in a vertical plane containing the vertical profile 31b1 of the stationary frame 31, with this plane being perpendicular to the leaves V, V′ and therefore perpendicular to the frames 30 and 31. In this configuration, the open face 13 is adjacent to the stationary frame 31, and located outside of the space separating the opening frame 30 of said stationary frame 31 when the window F is in the intermediate open position. The open face 13 is delimited laterally on the one hand by the lateral edge C1 of the duct C, and on the other hand by the vertical profile 31b1 of the stationary frame 31.

A transparent plate 14 extends between the opening frame 30 and the stationary frame 31, from the open face 13 of the duct C to the opening frame 30, in such a way that said conduit and said plate define the ventilation passage 1.

The plate 14 is for example made from glass or plexiglas. It is formed by a profile of the corner or angle type and has a cross-section in the shape of an L. A first end 141 of the plate 14 is integral with the lateral end C1 of the duct C, for example by gluing. The other end 142 of the plate 14 is separated by about 5 cm to 20 cm from the vertical profile 31b1, towards the glass panel 4. This second end 142 is advantageously in contact with at least the horizontal profiles 30a of the opening frame 30, and where applicable with the glass panel 4. The plate 14 as such extends the duct C to the first end 10 of the ventilation passage 1.

Although it partially covers the glass panel 4, the plate 14 being transparent, it does not reduce the total glazed surface of the window F or the lighting of the room L.

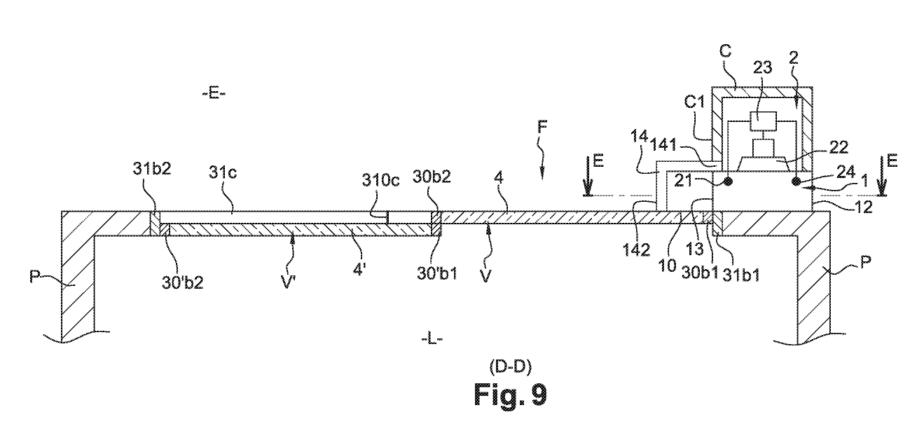

In the closed position shown in FIGS. 9, 10 and 13, the window F hermetically closes the first end 10 of the ventilation passage 1 in such a way as to prevent any ventilation between the inside and outside E the room L, including by said ventilation passage. Indeed, given that the lateral vertical profile 30b1 of the opening frame 30 is hermetically attached to the corresponding vertical profile 31b1 of the stationary frame 31, the first end 10 of the ventilation passage 1 is closed by said opening frame, in particular by the glass panel 4. The air therefore cannot circulate in the duct C.

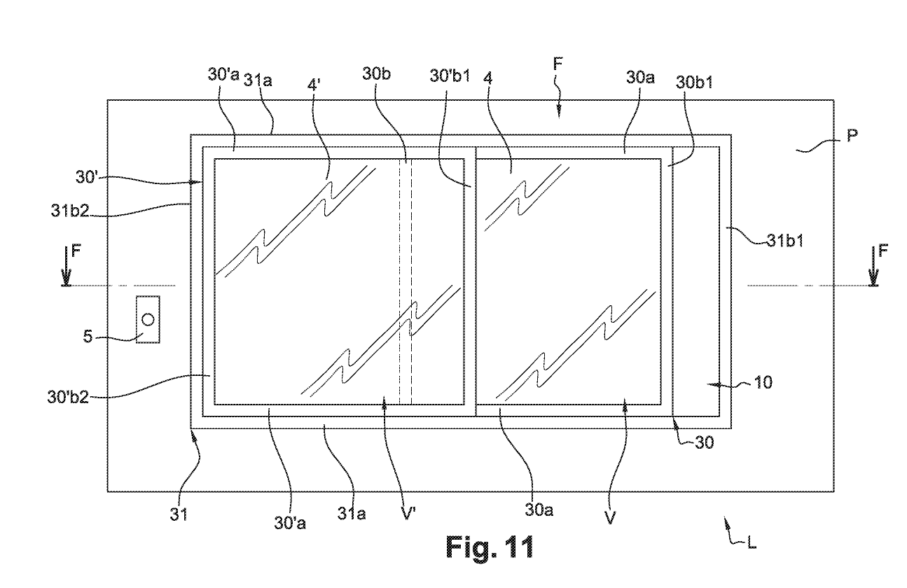

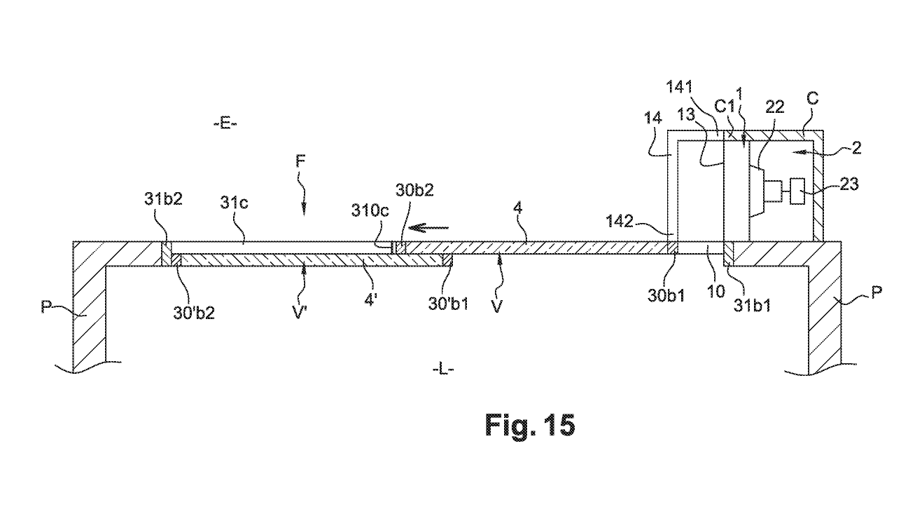

In the intermediate open position shown in FIGS. 11, 12 and 15, the leaf V slides in such a way that the lateral vertical profile 30b1 of the opening frame 30 is moved away from the corresponding vertical profile 31b1 of the stationary frame 31 by a predetermined distance (for example between 2 cm and 15 cm, preferably 10 cm) and is positioned facing the second end 142 of the plate 14. The first end 10 of the ventilation passage 1 then opens into the space that separates the lateral vertical profile 30b1 of the opening frame 30 from the corresponding vertical profile 31b1 of the stationary frame 31 and allows for natural ventilation between the inside and outside E the room L only by said passage. The space located between the lateral vertical profile 30b1 of the opening frame 30 and the other vertical profile 31b2 of the stationary frame 31 which is opposite the vertical profile 31b1, is entirely closed by the glass panels 4 and 4′, in such a way that the air cannot circulate at this level between the inside and outside E the room L. When the user wishes to open the leaf V further, i.e. beyond the intermediate open position, there is a natural ventilation between the inside and outside E the room L not only by the ventilation passage 1, but also at the space located between the lateral vertical profile 30b1 of the opening frame 30 and the second end 142 of the plate 14.

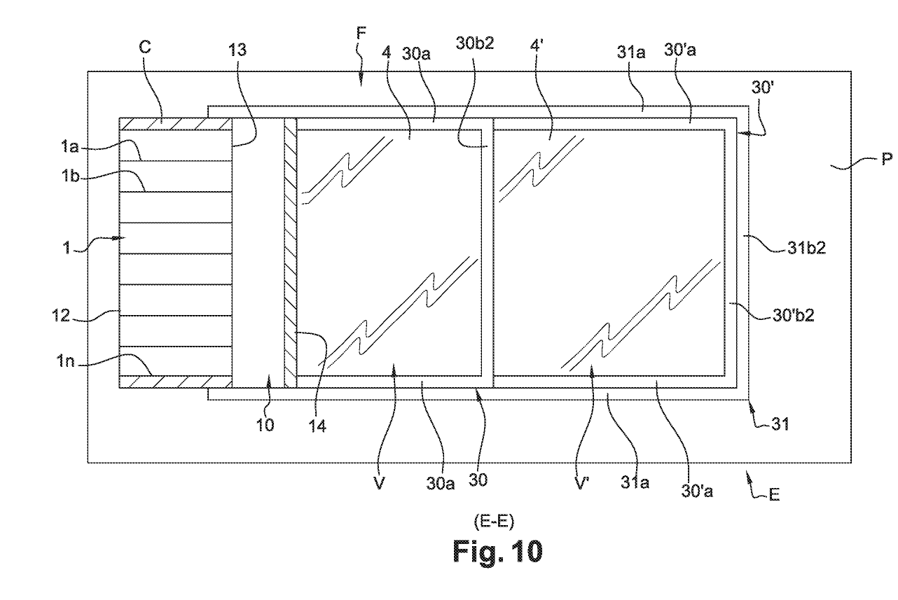

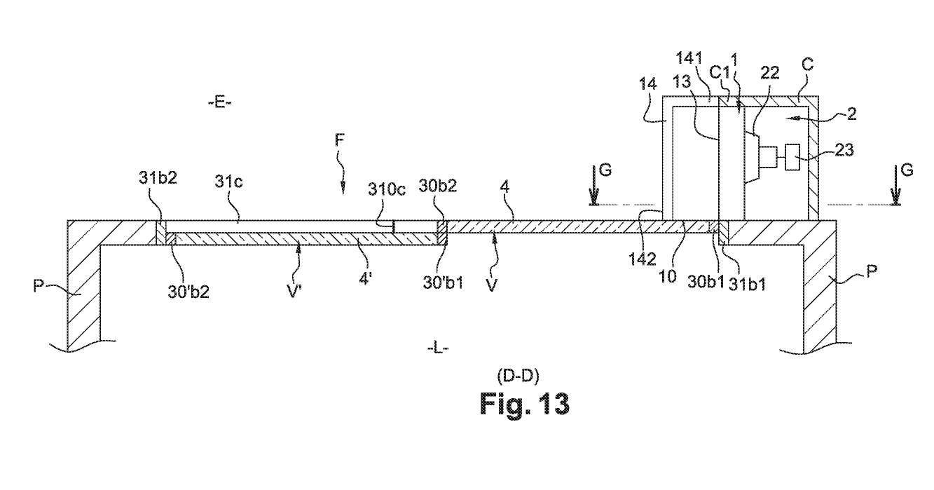

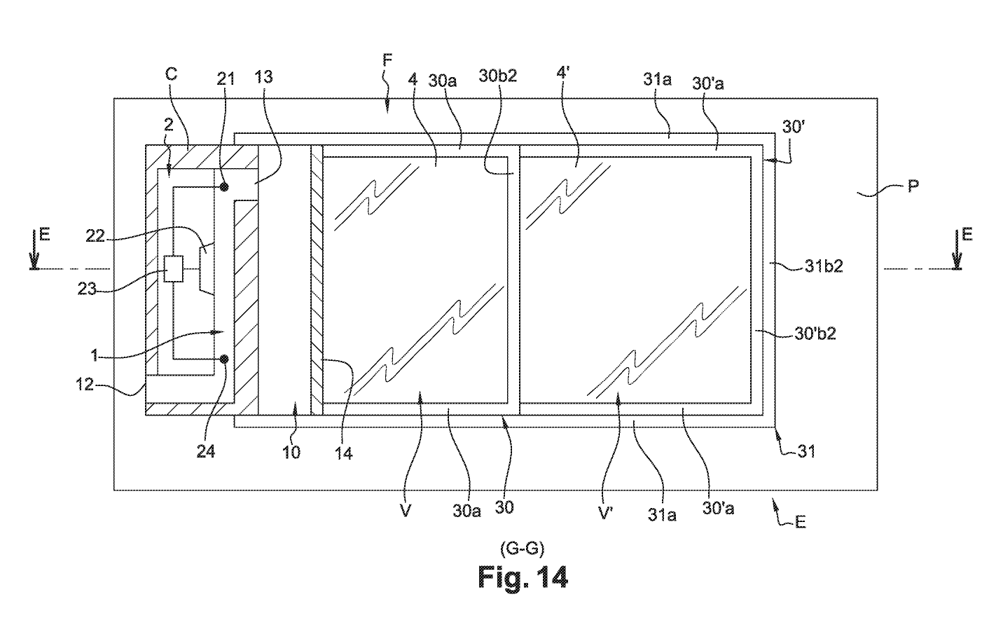

In FIG. 10, the ventilation passage 1 has several channels 1a, 1b, . . . , 1n superimposed parallel one above the other. These various channels are similar to those described hereinabove in reference to FIGS. 1 to 4. In FIGS. 13 to 15, the ventilation passage has a single canal which is similar to the one described hereinabove in reference to FIG. 7.

A noise absorber 2 is associated with the ventilation passage 1. This absorber is used for an active or passive control of the noise.

An active absorber 2 generates, in the ventilation passage 1, a sound level equivalent to the ambient sound level to be controlled, in particular a noise coming from one or several noise sources located outside E of the room L. In practice, this active absorber 2 generates a counter-noise which is superimposed on the sound waves propagating in the ventilation passage 1.

The active noise absorber 2 can have the form of a piezoelectric actuator or a loudspeaker. Preferably use is made of a linear loudspeaker of the type described in U.S. Patent document 6.285.773 (Carme) mentioned hereinabove, and to which those skilled in the art can refer where applicable. This type of linear loudspeaker can indeed be housed easily in a reduced volume and in particular in a narrow space, while still having an output comparable to that of a conventional loudspeaker with conical membranes. The geometrical shape and the particular arrangement of the elements that comprise the linear loudspeaker offer a very satisfactory output. In particular, in light of the substantial length of the membrane, the latter displaces a large mass of air during its vibration, which allows for good output in the low frequencies. This linear loudspeaker is for example installed vertically over the entire length of the duct C.

The linear loudspeaker can however be replaced with several circular loudspeakers installed side-by-side in the duct C and in particular, in the case where this duct is tiered, in each one of the channels 1a, 1b, . . . , 1n. It is possible for example to use ASCA loudspeakers marketed by the applicant.

Use will be made in the rest of the description of the generic term loudspeaker, bearing the reference 22, whether the latter is a loudspeaker as such (linear or circular) or a piezoelectric actuator.

The noise absorber 2 can include a single linear loudspeaker 22 arranged on a single of the sides of the duct C, or several circular loudspeakers. The choice of the number of loudspeakers and of their arrangement in the duct C depends on the sound field to be attenuated, by superposition, of the noises propagating in the ventilation passage 1, in order to increase the sound insulation as soon as the window is in the intermediate open position.

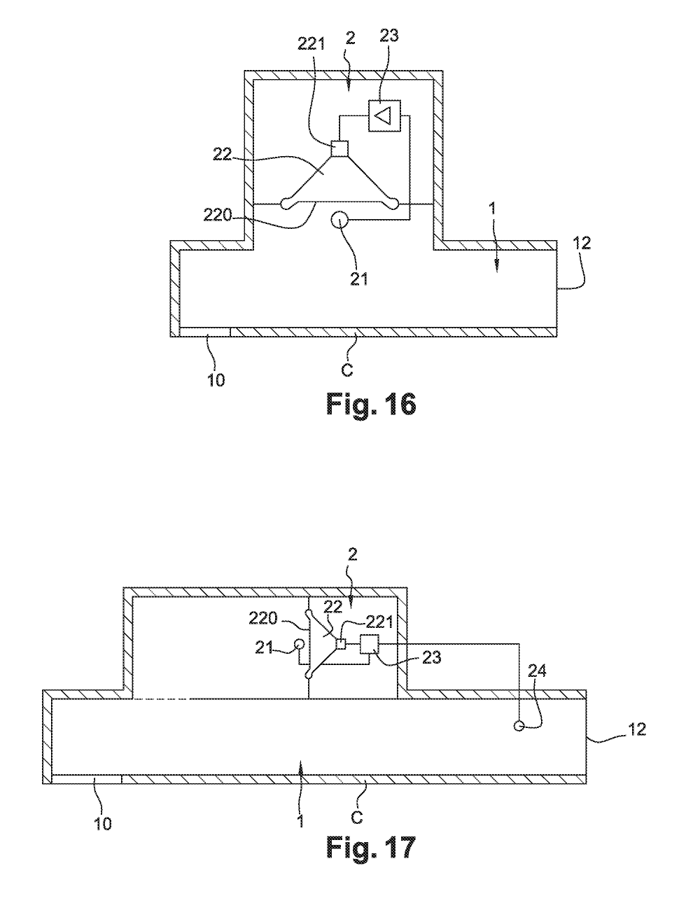

In FIG. 16, the loudspeaker 22 comprises a membrane 220 suitable for vibrating and generating a counter-noise in the ventilation passage 1. An actuator 221 is associated with the membrane 220. This actuator 221 is adapted for inducing a vibratory movement to the membrane 220. This can be a piezoelectric actuator or more conventionally an actuator using an arrangement of magnets and a coil electrically excited to cause the vibration of the membrane 220 which generates the counter-noise.

At least one microphone 21 is installed in the ventilation passage 1 in order to sense the acoustic signals propagating in the latter. By way of example it is possible to use a microphone of the PUI Audio brand bearing the reference POM-2246L-C33-R and manufactured by the company PUI Audio.

The microphone 21 sends a signal that represents the noise in the ventilation passage 1 to a control electronics 23. Then, the control electronics 23 emits a control signal to the actuator 221 according to the acoustic signals sensed by the microphone 21. The absorber 2 as such makes it possible to increase the sound insulation of the window F when it is in the intermediate open position.

In a manner known to those skilled in the art, the control electronics 23 can implement a filtration by feedback and/or a filtration by feedforward. In the case of a filtration by feedback FEEDBACK, the microphone 21 is a control microphone, or of error. In the case of a filtration by feedforward FEEDFORWARD or of a hybrid filtering FEEDBACK-FEEDFORWARD, the microphone 21 is an error microphone arranged in the vicinity of the first end 10 of the ventilation passage 1 and another reference microphone 24 (FIGS. 2, 5, 9, 12, 14 and 16) is provided arranged in the vicinity of the second end 12 of said passage. By way of example it is possible to use a reference microphone 24 of the PUI Audio brand bearing the reference POM-2246L-C33-R and manufactured by the company PUI Audio.

The assembly of FIG. 16 is that described in European patent EP0898774 (FRAUNHOFER) and the assembly of FIG. 17 is that described in American patent U.S. Pat. No. 6,963,647 (FRAUNHOFER), to which those skilled in the art can refer in case of need.

It is not necessary for the noise absorber 2 to be activated when the window F is in the closed position. To this effect, a switch is adapted to activate the noise absorber 2. In FIGS. 1, 4, 8 and 11, the switch 5 has the form of a rocker switch or a push-button installed in the room L, on a wall P, which switch is of the type conventionally used for lighting. By manipulating this switch 5, the user can activate or deactivate the noise absorber 2, for example by controlling the electrical power supply of the control electronics 23.

In an alternative embodiment shown in FIG. 5, it is provided that the switch 5′ be controlled by the movement of the window F in such a way that when said window passes from the closed position to the intermediate open position, said switch 5′ automatically activates the noise absorber 2. To this effect, a position sensor 50′ can be installed on the lateral vertical profile 30b1 of the opening frame 30 and/or on the lateral edge C1 of the duct C or on the second end 142 of the plate 14. When the window is in the intermediate open position, the position sensor 50′ cooperates with the switch 5′ so that the latter automatically activates the noise absorber 2. This switch 5′ can also be adapted to automatically deactivate the noise absorber 2 when the window F is in the closed position or when it is not in the intermediate open position.

The absorber 2 can also be passive, i.e. it is adapted to absorb all or a portion of the sound waves propagating in the ventilation passage 1. To do this, it is advantageous that the inner walls of the duct C delimiting the ventilation passage 1 be covered with a sound-insulation material.

In order to further improve the noise reduction in the ventilation passage 1, it is advantageous to combine an active attenuation through the use of the active absorber 2 and a passive attenuation by the covering all or a portion of the inner walls of the duct C.

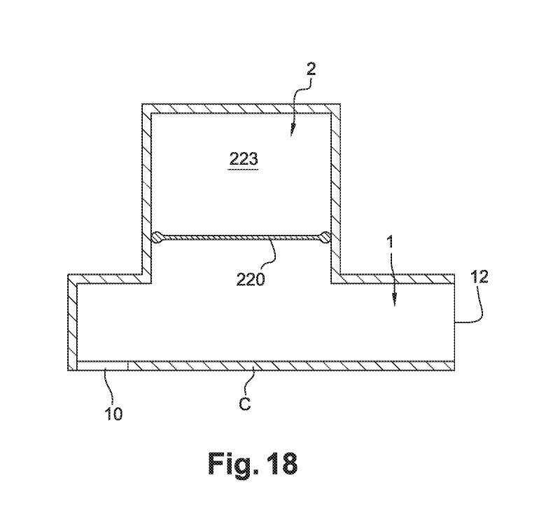

In FIG. 18, the absorber 2 is passive. A flexible membrane 220 is simply suspended at the side walls of a cavity 223 arranged in the duct C. The membrane 220 closes the cavity 223 in such a way as to be able to vibrate in the ventilation passage 1. In this configuration, the membrane 220 absorbs all or a portion of the sound waves propagating in the ventilation passage 1, making it possible to increase the sound insulation. The membrane 220 is for example formed by a film with elastic properties, such as an elastomer having an elastic power or a polyethylene film.

The arrangement of the various elements and/or means and/or steps of the invention, in the embodiments described hereinabove, must not be understood as requiring such an arrangement in all of the implementations. In any case, it is understood that diverse modifications can be made to these elements and/or means and/or steps, without leaving the spirit and the scope of the invention. In particular:
The room L can be a particular compartment, such as the compartment of a motor vehicle, of a train, and even of an aircraft. The walls P are then for example formed from sheets.
The window F can include a single leaf V formed by the opening frame 30 mounted mobile in the stationary frame 31, or more than two leaves.
The two leaves V, V′ can be able to be displaced by laterally sliding in parallel planes on horizontal support rails mounted at the lower portion of the fixed stationary frame 31.
The leaf V can be displaced by vertically sliding over one or several vertical support rails mounted in the lateral portion of the stationary frame 31, and in particular in the vertical profiles 31b.
The frames 30 and 31 are preferably of rectangular or square shape, but can be of polygonal shape, have one or several curved edges, etc.
The duct C formant the passage 1 can be installed inside of the room L.
The natural ventilation in the passage 1 can be done from the outside of the room L towards the outside E; or from the inside of the room L to the outside E.
The element 310c forming an abutment can have any other form that suits those skilled in the art.
The ventilation passage 1 and the noise absorber 2 can be associated with a tilting window wherein the opening frame 30 is mounted movable in rotation in the stationary frame 31.

1-15. (canceled)

16. An apparatus for natural ventilation of a room, comprising:
a room delimited by walls,
at least one door or one window installed in one of the room walls, which door or which window comprises an opening frame supporting a glass panel, which opening frame is mounted so as to move in a fixed stationary frame surrounding said opening frame,
a ventilation passage provided on the door or the window and which communicates between the outside of the room and the inside of the room in such a way as to allow natural ventilation between the outside and inside of said room, which passage has a first end opening into the room and a second end opening to the outside of said room,
a noise absorber capable of attenuating sound waves propagating in the ventilation passage, the attenuation being realized by the generation of a counter-noise which is superimposed on said sound waves,
the door or the window is mounted so as to move between:
a closed position wherein a profile of the opening frame is hermetically attached to a profile of the stationary frame in such a way as to prevent any ventilation between the inside and outside of the room by the door or the window,
and an open position wherein the profile of the opening frame is detached and separated from the profile of the stationary frame in such a way as to allow natural ventilation between the inside and outside of the room by the door or the window, wherein
in the closed position, the opening frame hermetically closes the first end of the ventilation passage in such a way as to prevent any ventilation between the inside and outside of the room by said ventilation passage,
in an intermediate open position, the opening frame frees the first end of the ventilation passage, which first end opens into the space separating the profile of the opening frame of the profile of the stationary frame, in such a way as to allow natural ventilation between the inside and outside of the room only by said ventilation passage.

17. The apparatus according to claim 16, wherein, in the intermediate open position, the profile of the opening frame is separated from the profile of the stationary frame by a distance between 2 cm and 15 cm.

18. The apparatus according to claim 16, wherein the first end of the ventilation passage extending vertically along the door or the window, over a length corresponding substantially to that of the vertical profiles of the opening frame.

19. The apparatus according to claim 16, wherein the noise absorber includes at least one microphone arranged to sense the noise in the ventilation passage and at least one loudspeaker adapted to generate a counter-noise in the ventilation passage in response to the noise sensed by the microphone.

20. The apparatus according to claim 19, wherein a switch is adapted to activate the noise absorber.

21. The apparatus according to claim 20, wherein the switch is adapted to be controlled by the movement of the door or of the window in such a way that when said door or said window passes from the closed position to the intermediate open position, said switch automatically activates the noise absorber.

22. The apparatus according to claim 21, wherein the switch is adapted to automatically deactivate the noise absorber when the door or the window is in the closed position.

23. The apparatus according to claim 16, wherein the ventilation passage has the form of a duct added onto the wall of the room where the door or the window is installed.

24. The apparatus according to claim 16, wherein the ventilation passage has the form of a duct integrated into the wall of the room where the door or the window is installed, outside said room.

25. The apparatus according to claim 23, wherein the duct has inner walls that delimit the ventilation passage, which walls are covered with a sound-insulating material.

26. The apparatus according to claim 16, wherein the stationary frame is provided with at least one rail whereon slides at least one profile of the opening frame, which rail is provided with an element forming an abutment when the opening frame is in the intermediate open position.

27. The apparatus according to claim 16, wherein:
a duct having an open face is installed in such a way that said open face is adjacent to the stationary frame, and located outside of the space that separates the profile of the opening frame from the profile of said stationary frame,
a transparent plate extends between the opening frame and the stationary frame, from the open face of the duct to the opening frame, which plate extends said duct to the first end of the ventilation passage,
the duct and the transparent plate define the ventilation passage.

28. The apparatus according to claim 16, wherein the ventilation passage has the shape of a chicane.

29. The apparatus according to claim 16, wherein the ventilation passage has several channels superimposed parallel one above the other.

30. The apparatus according to claim 16, wherein the inner walls of a duct delimiting the ventilation passage are covered with a sound-insulating material.
